(19) United States
(12) Patent Application Publication
(10) Pub. No.: US 2008/0011430 A1
(43) Pub. Date: Jan. 17, 2008

(54) Shade without threading cords

(76) Inventor: Ya Li Lin, Shalu Township (TW)

Correspondence Address: BRUCE H. TROXELL, SUITE 1404, 5205 LEESBURG PIKE, FALLS CHURCH, VA, 22041, US

(21) Appl. No.: 11/486,205

(22) Filed: Jul. 14, 2006

(51) Int. Cl. E06B 9/26

(52) U.S. Cl. 160/166.1

(57) ABSTRACT

A shade without threading cords that does not have threading cords to link transverse slats includes a plurality of transverse slats and at least two longitudinal bands bonding to the transverse slats. Each of the transverse slats has at least two bonding zones which are a bondable surface. Each band has a first band surface coated with adhesive to facilitate bonding and anchoring of the transverse slats. The shade can be arranged and assembled quickly because no threading cords are needed. Fabrication of the shade is easier, and sideward movement of the transverse slats can be prevented.

### BACKGROUND OF THE INVENTION

1. Field of the Invention

The present invention relates to a shade without threading cords and particularly to a shade that does not have treading cords to link transverse slats to facilitate fabrication and prevent the slats from moving sideward.

2. Description of the Prior Art

Window coverings generally can be categorized in blinds, curtains and shades. The blinds generally are formed in a plain style and do not have much aesthetic appeal, and need a greater effort during winding and retraction, thus are mostly used in offices. The curtains and shades are more elegant and attractive, thus are widely used in houses. As the curtains also require a greater effort during winding and retraction, the shades become increasingly popular. Refer to FIG. 1 for a typical shade structure. It includes fabric panels 11, 12 and 13 that are movable transversely through drawing bars 111, 112 and 113 to block light and decorate the environment. As the demand of indoor decoration becomes more diversified these days, the shade made merely from fabrics cannot fully meet actual requirements. This is especially true in recent years when health and green concept gains growing awareness and building with natural means is trendy. Bamboo and wood become popular materials in construction and making household goods. To make a shade 2 from bamboo or wood (as shown in FIG. 2), a plurality of threading cords 211 have to be used to link a plurality of transverse slats 21 through weaving machines. Threading the cords is tedious and time-consuming. When the shade 2 is subject to a transverse force, the slats that receive the force are easily bulged sideward. It is an annoyance for users.

### SUMMARY OF THE INVENTION

In view of the aforesaid problems occurred to the conventional shade, the present invention aims to provide a shade that does not need threading cords to link transverse slats. The shade according to the invention includes a plurality of transverse slats and at least two longitudinal bands to bond the slats. Each transverse slat has at least two bonding zones which have a bondable surface to be bonded and anchored by a first band surface of the band coated with adhesive. Thus coupling between the transverse slats and the band is stronger, and no linking of the threading cords is needed. The transverse slats can be arranged and assembled rapidly to form the shade. Fabrication is easier, and sideward movement of the transverse slats can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional shade.

FIG. 2 is a schematic view of a conventional shade moving sideward under a transverse force.

FIG. 3 is a perspective view of the invention.

FIG. 4 is another perspective view of the invention.

FIG. 5 is a sectional view of the invention in an assembled condition.

FIG. 6 is a fragmentary exploded view of the invention.

FIG. 7 is a fragmentary sectional view of the invention.

FIG. 8 is a fragmentary sectional view of another embodiment of the invention.

FIG. 9 is a fragmentary sectional view of a further embodiment of the invention.

FIG. 10 is a fragmentary sectional view of yet another embodiment of the invention.

FIG. 11 is a fragmentary sectional view of still another embodiment of the invention.

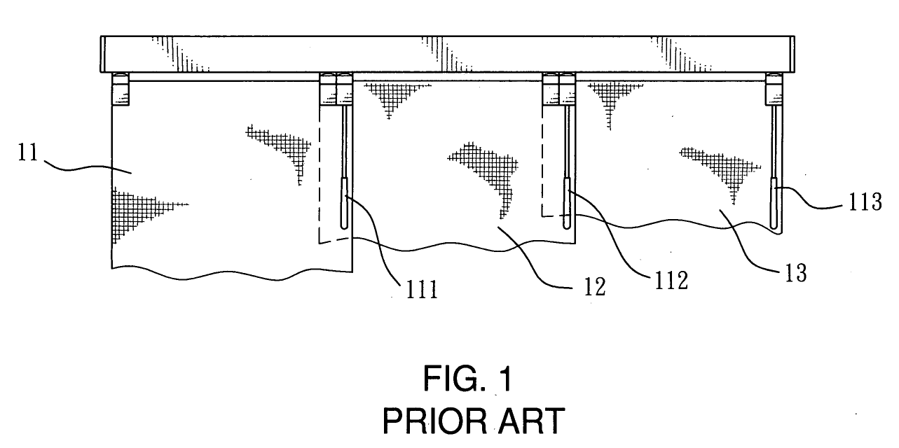

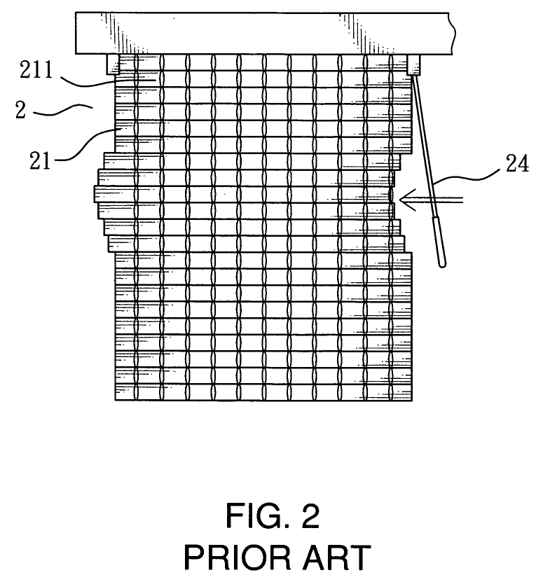

### DESCRIPTION OF THE PREFERRED EMBODIMENTS

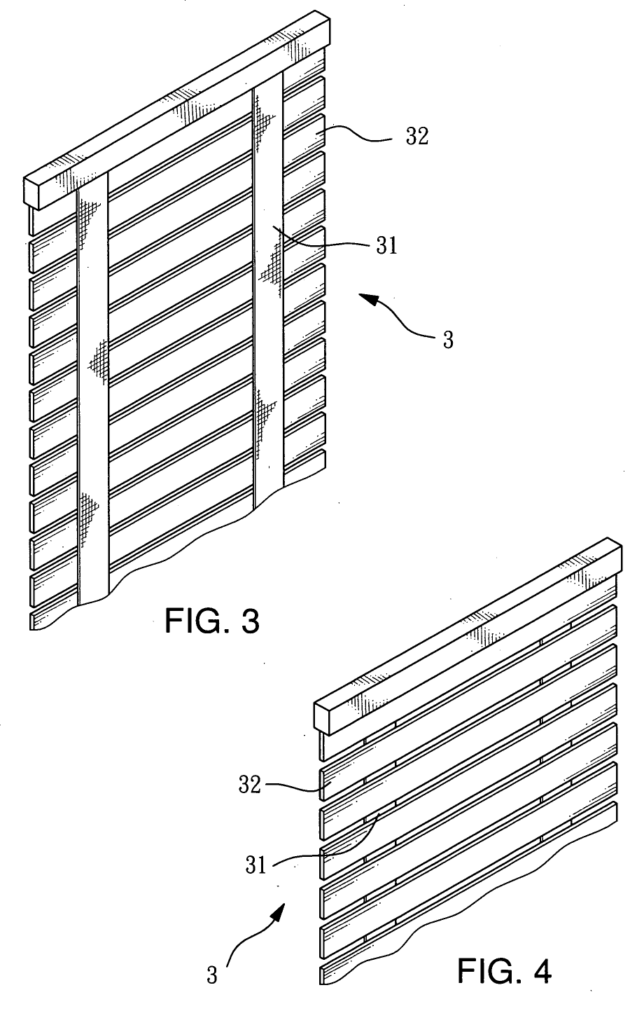

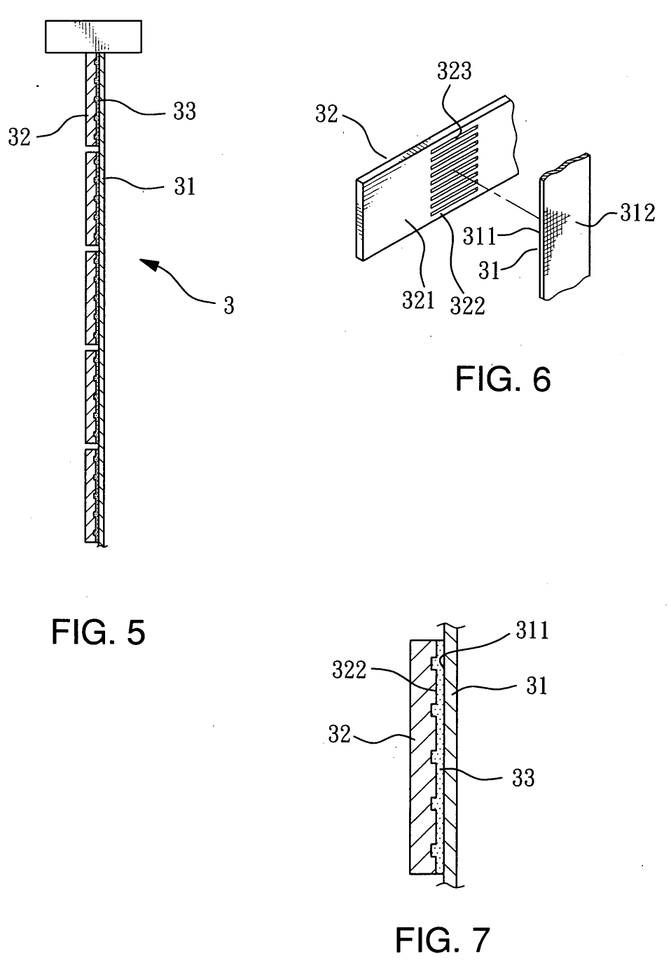

Referring to FIGS. 3 through 6, the shade 3 according to the invention includes a plurality of transverse slats 32 and at least two longitudinal bands 31 bonding to the slats 32.

Each of the transverse slats 32 has a first slat surface 321 which has at least two bonding zones 322. The bonding zones 322 are a surface bondable easily.

Each of the bands 31 has a first band surface 311 coated with adhesive 33 to bond the bonding zones 322 of the transverse slats 32. The band 31 has a second band surface 312 which may be formed with patterns to enhance ornamental effect.

By means of the construction set forth above, the transverse slats 32 are coupled with the bands 31 by bonding. Hence the inconvenience of threading and weaving processes occurred to the conventional techniques can be overcome. The shade 3 can be arranged and assembled rapidly. Sideward movement of the transverse slats 32 also can be prevented.

Referring to FIGS. 6 and 7, as the bonding zone 322 of the transverse slat 32 is a surface bondable easily, to achieve this object, the surface of the bonding zone 322 may be formed with a plurality of jagged strips 323 or other coarse surface structures. Thereby the adhesive 33 (such as heat melting gum, resin or the like) can be coated and anchored more securely.

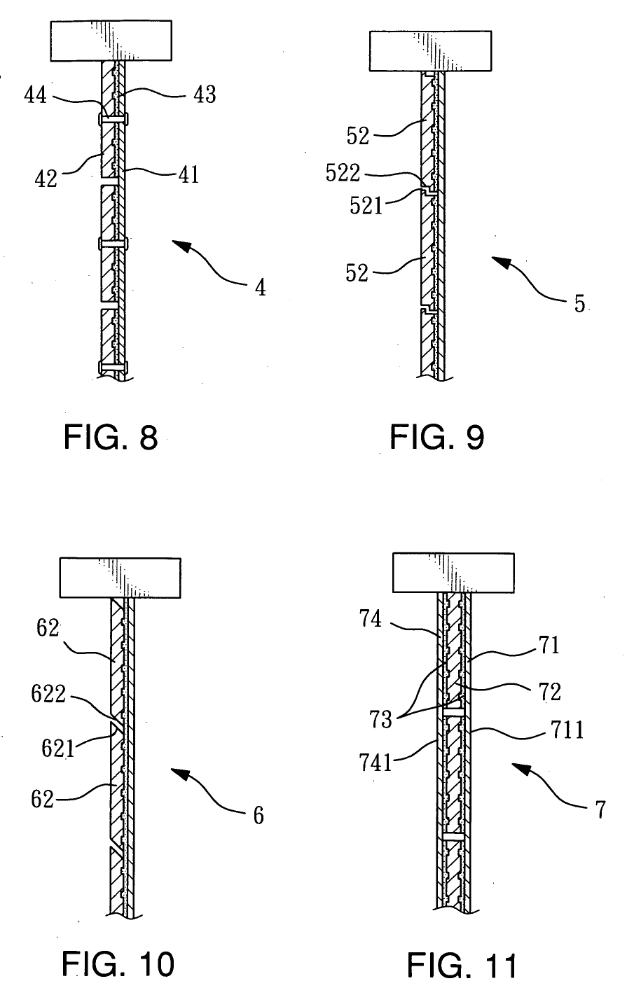

Refer to FIG. 8 for a second embodiment of the invention. A shade 4 includes transverse slats 42 that are bonded by bands 41 through adhesive 43. To further enhance bonding and coupling, the transverse slat 42 is fastened to the band 41 by a rivet 44 running through them transversely.

Refer to FIG. 9 for a third embodiment of the invention. Each transverse slat 52 of the shade 5 has a flange 521 on a upper edge and a notch 522 on a lower edge at a corresponding location. Hence two neighboring slats 52 on the upper side and lower side can be coupled together through the flange 521 and notch 522. As a result, the gap between the upper and lower transverse slats 52 is masked to block light more effectively.

Refer to FIG. 10 for a fourth embodiment of the invention. Each transverse slat 62 of the shade 6 has a first inclined edge 621 on a upper side and a second inclined edge 622 on a lower side at a corresponding location. Hence two neighboring slats 52 on the upper side and lower side can be coupled together through the corresponding first inclined edge 621 and the second inclined edge 622. As a result, the gap between the upper and lower transverse slats 62 is masked to block light more effectively.

Refer to FIG. 11 for a fifth embodiment of the invention. Each transverse slat 72 of the shade 7 has two outer sides to be bonded respectively to two bands 71 and 74 through adhesive 73 to further enhance bonding and anchoring effect. The bands 71 and 74 have second band surfaces 711 and 741 on the outer sides of the shade 7 that can be formed with patterns to enhance ornamental effect.

In short, through the invention, shades can arranged and assembled quickly without threading cords running through the transverse slats. Fabrication is easier and sideward movement of the transverse slats can be prevented

I claim:

1. A shade without threading cords comprising a plurality of transverse slats and at least two longitudinal bands bonding to the transverse slats; wherein:
each of the transverse slats has a first slat surface which has at least two bonding zones, the bonding zones being a bondable surface;
each of the bands has a first band surface coated with adhesive to be bonded to the bonding zones of the transverse slats.

2. The shade of claim 1, wherein the bands have a second band surface which has patterns formed thereon.

3. The shade of claim 1, wherein the bonding zones have a coarse surface.

4. The shade of claim 1, wherein the bands and the transverse slats are fastened by running through a rivet.

5. The shade of claim 1, wherein each of the transverse slats has a flange on a upper edge and a notch on a lower edge at a corresponding location.

6. The shade of claim 1, wherein each of the transverse slats has a first inclined edge on a upper side and a second inclined edge on a lower side at a corresponding location.
